(19) United States
(12) Patent Application Publication
(10) Pub. No.: US 2007/0195493 A1
(43) Pub. Date: Aug. 23, 2007

(54) Assembly mechanism

(76) Inventors: Jung-Wen Chang, Lu Chu Hsiang (TW); Ching-Cheng Wang, Dashi Township (TW)

Correspondence Address: RABIN & BERDO, P.C.;Suite 500, 1101 14 Street, N.W., Washington, DC, 20005, US

(21) Appl. No.: 11/495,616

(22) Filed: Jul. 31, 2006

(30) Foreign Application Priority Data
Feb. 22, 2006 (TW) 95203020

(51) Int. Cl. G06F 1/16

(52) U.S. Cl. 361/681

(57) ABSTRACT

The assembly mechanism utilized to combine a display unit and a circuit unit comprises a front shell a rear shell and a combination member wherein the combination member placed between the front shell and the rear shell comprises a first surface with a first connecting portion and a second surface with a second portion. The display unit is placed between the front shell and the first surface whereby the display unit is fastened. The circuit unit is placed between the rear shell and the second surface whereby the circuit unit is fastened.

### RELATED APPLICATIONS

The present application is based on, and claims priority from, Taiwan Application Serial Number 95203020, filed Feb. 22, 2006, the disclosure of which is hereby incorporated by reference herein in its entirety.

### BACKGROUND

1. Field of Invention

The present invention relates to an assembly mechanism and computer device. More particularly, the present invention relates to an easy assembly/disassembly mechanism.

2. Description of Related Art

The main disadvantage of traditional desktop personal computers (PCs) is the large space occupied by the desktop PC and especially the display unit and the host. Thus a newly designed computer device for overcoming this disadvantage is proposed. The idea of the new design is to integrate the motherboard and display in a single shell such as an Apple G5 computer device and tablet PC Those devices reduce the total space required for storage significantly. In order to integrate the display unit and the host in a limited space, maintenance issues are inclined to be ignored and would be inconvenient when being fixed.

FIG. 1 shows an exploded view of a conventional tablet PC 10 comprising a bracket 102 a display unit 104 a circuit unit 106 (such as a motherboard) a front shell 110 and a rear shell 112. The ordered assembly steps for a tablet PC 10 require the circuit unit 106 to be set by the bracket 102 inside the rear shell 112 first, and then set the display unit 104 on the circuit unit 106 completing the “integration.”

PC 10 and G5 mechanism disadvantage is that the display unit 104 and the bracket 102 have to be disassembled first if the user or maintenance engineer wants to fix the circuit unit 106. The additional steps included in the disassembly are not only inconvenient but also time-consuming and add to the total time required to fix or maintain the device. Another disadvantage is that during the assembly/disassembly step, the potential risk of abrasion collision and damage is increased.

### SUMMARY

It is therefore an aspect of the present invention to provide an assembly mechanism with the advantage of assembly and disassembly easily.

The assembly mechanism utilized combines a display unit and a circuit unit and comprises a front shell a rear shell and a combination member. The combination member is placed between the front shell and the rear shell and comprises a first surface with a first connecting portion and a second surface with a second connecting portion. The display unit is placed between the front shell and the first surface whereby the display unit is fastened. The circuit unit is placed between the rear shell and the second surface whereby the circuit unit is fastened.

Accordingly, the display unit and the circuit unit could be assembled and disassembled independently and no ordered assembly step has to be followed. The advantage of the easy assembly/disassembly for fixing a single unit device reduces the potential risk of abrasion collision and damage.

### BRIEF DESCRIPTION OF THE DRAWINGS

These and other features, aspects and advantages of the present invention will become better understood with regard to the following description, appended claims and accompanying drawings where:

FIG. 1 is an exploded view of a conventional tablet PC;

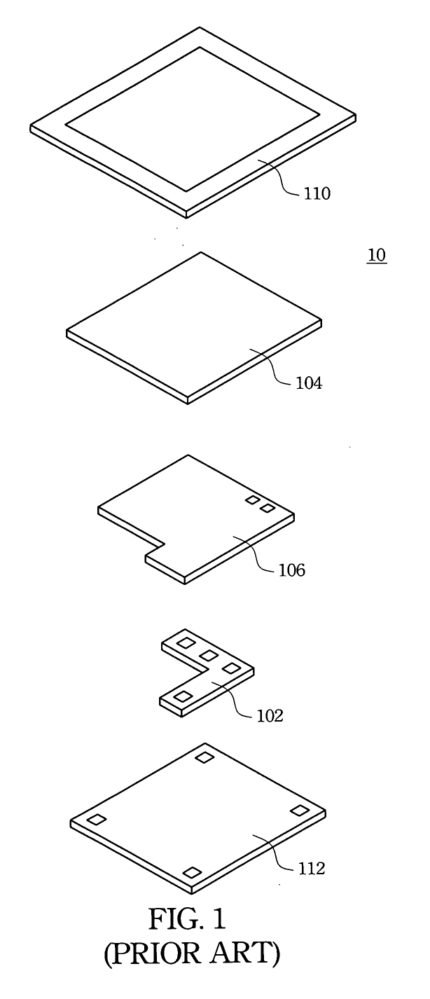

FIG. 2 is a sectional view of an assembly mechanism in a computer device in accordance with a preferred embodiment of the present invention;

FIG. 3 is an exploded view of an assembly mechanism in a computer device in accordance with a preferred embodiment of the present invention; and

FIG. 4 is a sectional view of an assembly mechanism apparatus in a computer device in accordance with another preferred embodiment of the present invention.

### DESCRIPTION OF THE PREFERRED EMBODIMENTS

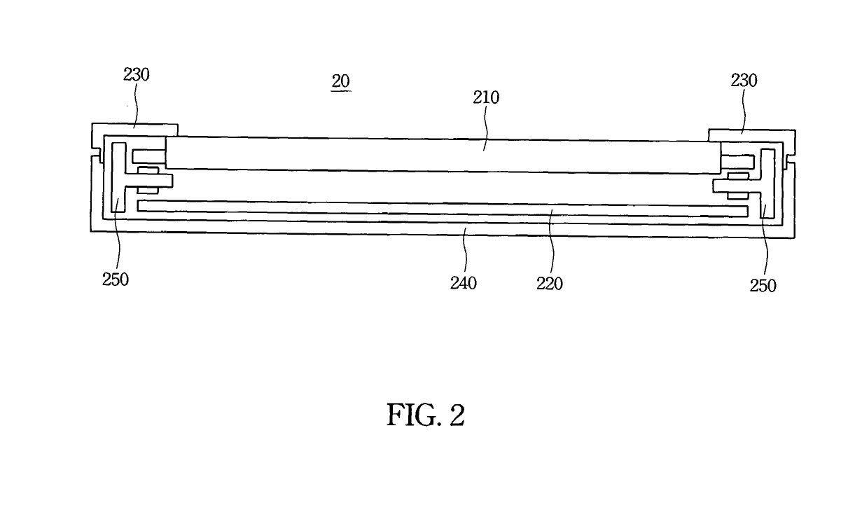

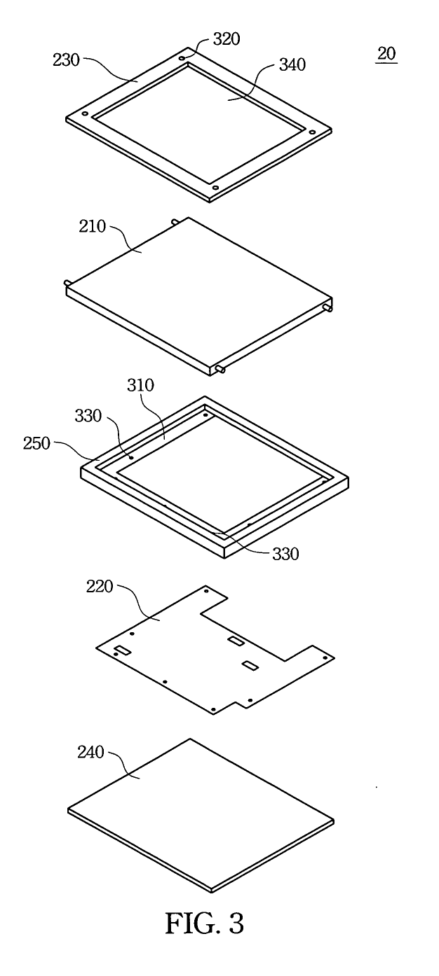

FIG. 2 shows a sectional view of an assembly mechanism in a computer device in accordance with a preferred embodiment of the present invention. In FIG. 2, The computer device 20 comprises a display unit 210 such as an LCD (liquid crystal display) or an OLCD (organic liquid crystal display), a circuit unit 220 such as motherboard or a module for a specific function like blue-tooth modem or wireless, and an assembly mechanism including a front shell 230 with a front connecting portion 320 (FIG. 3), a rear shell 240 with a rear connecting portion (not shown) and a combination member 250. The center of the front shell 230 is hollow and covered by a thin transparent material (such as glass or plastic) so that the front shell 230 does not cover the display unit 210 and the display unit 210 can be easily viewed by a user. The front shell 230 also protects the display unit 210 (water-proof and scrape-proof). Moreover, the thin transparent material could be chosen to enhance the contrast and saturation to make the display unit 210 more colorful. Besides, the display unit 210 could be a flat mirror panel with or without a touch screen function.

FIG. 3 shows an exploded view of an assembly mechanism in a computer device in accordance with a preferred embodiment of the present invention. In FIG. 3, the assembly mechanism is used to combine the display unit 210 and the circuit unit 220. The plastic or metal combination member 250, which may be hollow inside, is placed between the front shell 230 and the rear shell 240, The combination member 250 comprises a first surface 310 with a first connecting portion 330 such as a screw hole and a second surface with a second connecting portion (not shown) such as a screw hole. The second surface is set opposite to the first surface 310.

The display unit 210 is placed between the front shell 230 and the first surface 310 is fastened by the first connecting portion 330 of the combination member 250 and the front connecting portion 320 of the front shell 230. The circuit unit 220 is placed between the rear shell 240 and the second surface is fastened by the second connecting portion of the combination member 250. The circuit unit 220 is connected electronically with the display unit 210 via an electronic wire a cable or an FFC (Flexible Flat Cable).

According to the above, the display unit 210 and the circuit unit 220 could be assembled and disassembled independently on each side of the combination member 250. No ordered assembly step needs to be followed. In other words, if the display unit 210 is broken, just disassemble the front shell 230 and fix the display unit 210, and if the circuit unit 220 is broken, just disassemble the rear shell 240 and fix the circuit unit 220 while in the prior art in the latter case, the front shell 230 the display unit 210 and the combination member 250 all had to be removed (disassembled) first and then the user/maintenance engineer could only fix the circuit unit 220. Therefore, this invention not only saves maintenance and repair time (disassemble the non-broken member/unit) significantly but also reduces the potential risk of abrasion collision and damage during the disassembly and assembly step.

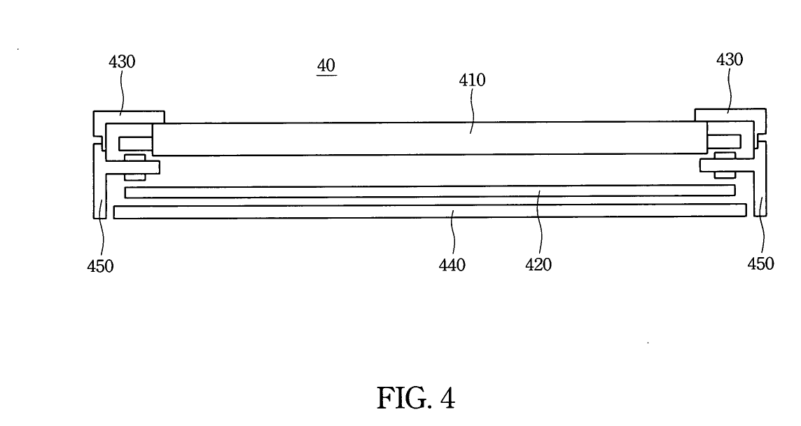

FIG. 4 shows a sectional view of an assembly mechanism apparatus in a computer device in accordance with another preferred embodiment of the present invention. The computer device 40 comprises a display unit 410 a circuit unit 420 and an assembly mechanism which includes a front shell 430 a rear shell 440 and a combination member 450. The distinction between FIG. 3 and FIG. 4 is the mechanism relationship between the combination member 250 and 450 the front shell 230 and 430 and the rear shell 240 and 440. In FIG. 3 the combination member 250 is set inside the shell comprising the front shell 230 and the rear shell 240. In FIG. 4 the combination member 450 is not. The combination member 450 combines the front shell 430 and the rear shell 440 to form a complete shell.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An assembly mechanism used to combine a display unit and a circuit unit, comprising:
a front shell with a front connecting portion;
a rear shell with rear connecting portion; and
a combination member placed between the front shell and the rear shell, comprising:
a first surface with a first connecting portion; and
a second surface with a second connecting portion.
wherein the center of the front shell is hollow.

2. The assembly mechanism as claimed in claim 1, wherein the combination member is made of plastic or metal.

3. The assembly mechanism as claimed in claim 1, wherein the center of the combination member is hollow.

4. The assembly mechanism as claimed in claim 1, wherein the first connecting portion and the second connecting portion includes at least one screw hole.

5. A computer device, comprising:
a display unit;
a circuit unit; and
an assembly mechanism, comprising
a front shell with a front connecting portion;
a rear shell with rear connecting portion; and
a combination member placed between the front shell and the rear shell, comprising:
a first surface with a first connecting portion; and
a second surface with a second connecting portion;
wherein the center of the front shell is hollow; the display unit is placed between the front shell and the first surface whereby the display unit is fixed with the first surface. The circuit unit is placed between the rear shell and the second surface whereby the circuit unit is fixed with the second surface.

6. The computer device as claimed in claim 5, wherein the combination member is made of plastic or metal.

7. The computer device as claimed in claim 5, wherein the center of the combination member is hollow.

8. The computer device as claimed in claim 5, wherein the circuit unit is a motherboard.

9. The computer device as claimed in claim 5, wherein the circuit unit is a wireless module.

10. The computer device as claimed in claim 5, wherein the hollow of the front shell is covered by a thin transparent material.

11. The computer device as claimed in claim 5, wherein the display unit is a LCD (liquid crystal display).

12. The computer device as claimed in claim 5, wherein the display unit is an OLCD (organic liquid crystal display).

13. The computer device as claimed in claim 5, wherein the display unit is a touch panel.

14. The computer device as claimed in claim 5, wherein the display unit is a flat mirror panel.
